(19) United States
(12) Patent Application Publication
(10) Pub. No.: US 2014/0208699 A1
(43) Pub. Date: Jul. 31, 2014

(54) DEVICE FOR TREATING PACKAGES, AND HOLDING-AND-CENTERING UNIT FOR PACKAGES

(71) Applicants: Markus Reiniger, Monchengladbach (DE); Martin Schach, Bochum (DE); Holger Stenner, Haltern am See (DE)

(72) Inventors: Markus Reiniger, Monchengladbach (DE); Martin Schach, Bochum (DE); Holger Stenner, Haltern am See (DE)

(73) Assignee: KHS GmbH, Dortmund (DE)

(21) Appl. No.: 14/342,436

(22) PCT Filed: Jul. 12, 2012
(86) PCT No.: PCT/EP2012/002929

§ 371 Date: Mar. 3, 2014

(30) Foreign Application Priority Data
Sep. 2, 2011 (DE) 10 2011 112 106.8
Sep. 2, 2011 (DE) 10 2011 112 281.1

(51) Int. Cl. B41J 3/407; B41J 11/00; B65B 31/04

(52) U.S. Cl. CPC B41J 3/4073; B65B 31/04; B41J 11/002
USPC 53/510; 53/131.2

(57) ABSTRACT

An apparatus for printing different colors on packages includes holding-and-centering units, each having a primary and a secondary part. The primary part is held at a holding position during package handling. The secondary part is mounted in the primary part to be rotatable about a vertical axis of the unit. The secondary part receives a functional element necessary for handling a package. A plurality of secondary parts adapted to different types, forms and/or sizes of packages are associated with the primary parts.

### RELATED APPLICATIONS

This application is the national stage entry under 35 USC 371 of PCT/EP2012/002929, filed on Jul. 12, 2012, which claims the benefit of the Sep. 2, 2011 priority dates of German applications DE 102011112281.1 and DE 102011112106.8, the contents of which are herein incorporated by reference in their entirety.

### FIELD OF INVENTION

The invention is directed to an apparatus for treating packages.

### BACKGROUND

Devices for treating packages are known in different embodiments. For example, DE 10 2009 043 497 A1 discloses devices in which the packages are each held on one and the same holding-and-centering unit (puck) during the entire transport from a package inlet to a package outlet, and the holding-and-centering units only release the packages at the package outlet from which the holding-and-centering units are then returned to the package inlet on a puck return transport path.

Printing systems for printing containers with the use of digital, electrical print heads that operate on the inkjet principle are known to the skilled person. In particular, printing systems or printing machines are also known in which a plurality of treating or printing positions, each for receiving a container that is to be printed, are formed on a transport element driven to rotate about at least one vertical axis, and on which the containers are printed using electronically triggered digital print heads that operate on the inkjet principle.

### SUMMARY

The object of the invention is to further develop a device that adapts easily to packages of different type, size, and form with high operational reliability, or that can be realized with low assembly effort and in a compact design with high operational reliability.

In further development of the invention, the device is configured, for example, in such a way that the handling positions are each configured on a printing segment having at least one print head, that every printing segment constitutes a fully functional assembly unit, and/or that the printing segments are arranged, preferably interchangeably, on a rotor or rotor-like machine element that can be driven to rotate about the machine axis, and/or that every printing segment exhibits a solenoid array forming the stator of the rotary drive for the holding-and-centering units, and/or the at least one incremental sensor for scanning the at least one coding of the holding-and-centering units and/or means for holding and/or releasing the holding-and-centering units, and/or that the printing segments each exhibit a pressure balancing tank for the printing color or printing ink and/or at least one pump for feeding the printing color or printing ink, preferably at least two pumps for feeding the printing color or printing ink and for discharging surplus printing color or printing ink, and/or that every printing segment exhibits at least one control electronics at least for triggering the print head, and/or that every handling position or every printing segment exhibits positioning drives for a height adjustment and/or for an angular adjustment of the print head, and/or that at least one coupling unit is provided on the printing segment or on its housing for an electrical connection as well as for a fluid connection of the printing segment with a coupling unit on the machine or rotor, and/or that mechanical centering and holding elements are provided on the respective printing segment or on its housing, and/or that dummy segments that match the printing segments in shape and size but that do not constitute a handling position are provided for an arrangement between printing segments, whereby the afore-mentioned features may be provided individually or in any desired combination.

“Packages” in the sense of the invention are packaging elements or containers usually used in the food industry and specifically also in the drinks sector, including, in particular, containers such as, for example bottles, cans, also soft packages, for example those produced from cardboard and/or plastic film and/or metal film.

The term “puck,” in the sense of the invention, is to be understood to mean a holding, centering, and aligning part on which a package element is held and moved from the package inlet to the package outlet through a packaging element transport path of the transport system and that preferably also provides a controlled orientation of the respective package for the latter's handling.

“Transport elements adjacent to one another for transport purposes” in the sense of the invention means transport elements or transport and treatment elements that are configured and arranged in such a way that, at transfer regions, they receive the pucks from an adjacent transport element that is ahead in a transport direction, hold them, and pass them to a transport element that is behind in a transport direction.

For the purpose of the invention the expressions “essentially”, “in essence” or “around” mean variations from the respective exact value by +/−10%, preferably by +/−5% and/or variations in the form of changes insignificant for the function.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

In particular, a holding-and-centering unit is disclosed and claimed in which the secondary part, in which the packaging element, the bottle or the container is held is mounted on or in a primary part and can be rotated and driven about a vertical axis, and can also be driven by a motor. In one embodiment, the secondary part forms the rotor of an electromagnetic direct drive, and for the controlled aligning and/or rotating of the packaging element to be effected in this way. To achieve this function, the secondary part is provided with a permanent magnet array that interacts with a stator of the electromagnetic direct rotary drive or with a solenoid array that forms the stator.

Alternatively, the secondary part may also comprise an infinitely controllable electric motor, in particular a servomotor. In this case, the primary part comprises the motor housing or consists essentially of the motor housing of an infinitely controllable motor.

Because the rotor or packaging element must be at any time in an angular position, at least one coding for the rotational angle position is ideally provided on the secondary part, and, if necessary, also on the primary part. The coding interacts with a suitable sensor or reading unit, in particular, one or a plurality of incremental sensors at the respective working position. Moreover, alternatively or additionally, the primary part can always be uniquely defined or definably executed in its rotational angle position relative to the respective handling positions by a form-fitting mounting, centering unit, or a coupling element provided such that only the relative rotational angle position of the secondary part to the primary part need be configured to be detectable by a sensor, reading unit etc. The position relative to the printing segment or print head can then be derived from this.

During the printing of empty packages, especially PET, PEN, PE or PP empty bottles, which represent the normal case, the packaging element should preferably be under a slight positive pressure. For this purpose, there is provided on the holding-and-centering unit a locking or mating piece for a coupling element on the machine or printing segment that is configured in the manner of a quick-acting coupling. With this, a vaporous or gaseous medium, e.g. compressed air, can be fed into the packaging element through an inner line, in this case the hollow interior space of the puck. The lower outlet of this inner line forms a central centering element/taper. For this, at least one transport and handling unit, ideally the first, is connected to a vapor or gas source or comprises a suitable compressor.

The locking element of the coupling is advantageously configured as a non-return valve. Alternatively, a non-return valve is provided in the inner line. In this way, after the preloading to a preload pressure with a vaporous and/or gaseous medium, e.g. compressed air, this preload pressure can be maintained in the packaging element over the entire packaging element transport or pressure section in this way.

### BRIEF DESCRIPTION OF THE DRAWINGS

The invention is explained in detail below through the use of embodiment examples with reference to the figures. In the figures:

FIG. 1 shows, in simplified schematic and perspective representation, a device or installation for the handling of packages by applying to the packages a furnishing in the form of a multiple print;

FIG. 2 shows, in simplified schematic representation, the device or installation for handling packages in plan view;

FIG. 3 depicts a schematic representation and plan view of the transport or conveyor path of the packages through the device shown in FIGS. 1 and 2;

FIG. 3 shows, in a perspective partial view one of the transport and treatment elements, consisting of a plurality of printing segments;

FIG. 4 shows, in perspective partial view, one of the transport and treatment elements;

FIG. 5 shows, in perspective representation, a printing segment of the transport and treatment element of FIG. 4;

FIGS. 6-8 show, in different representations, a holding-and-centering unit of the device of FIG. 1, also together with a packaging element configured as a bottle;

FIG. 9 shows a section through a holding-and-centering unit of the device of FIG. 1;

FIG. 10 shows, in positions a) and b,) the holding-and-centering unit in section together with a packaging element configured as a bottle in different operating statuses;

FIG. 11 shows, in position (a), in perspective representation, a primary part of a holding-and-centering unit and in positions (b)-(g) different secondary units that can be combined with the premier part of a holding-and-centering unit;

FIG. 12 shows, in perspective representation, a transport and treatment element of a further embodiment of the invention, preferably for use with the device or installation of FIG. 1;

FIGS. 13 and 14 show different views of a printing segment of the transport and treatment element of FIG. 12;

FIG. 15 shows a simplified horizontal section through the printing segment of FIGS. 13 and 14;

FIG. 16 shows a simplified vertical section through the printing segment of FIGS. 13 and 14;

FIGS. 17 and 18 each show, in perspective partial view, a dummy segment for use with the device or installation of FIG. 1 or with the transport and treatment element of FIG. 12.

### DETAILED DESCRIPTION

The device 1 in the figures is used to apply a furnishing, for example in the form of an imprint or multiple-pass print, to packages 2 in the form of bottles, either directly to the exterior or envelope surface of packages 2 or to labels, e.g. provided with partial furnishing, already affixed thereto.

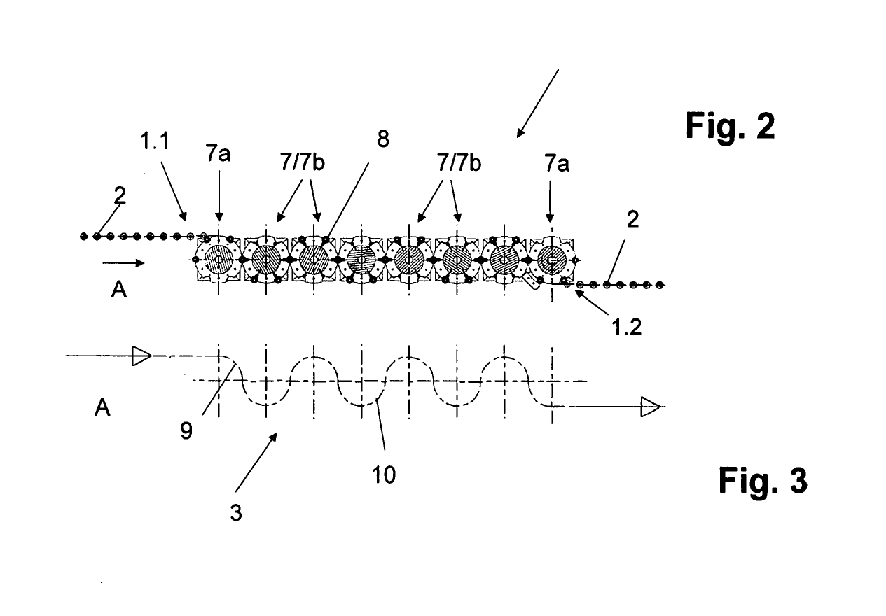

For printing, packages 2 are fed standing upright to device 1 or its package inlet by an external transporter in a transport direction A, The packages 2 move within device 1 on a multiply arcuate deviated conveyor section. After printing, packages 2 are fed, still standing upright, by an outer transporter to a subsequent use at a package outlet 1.2. A transport path 3 of the packages 2 when feeding, when moving through device 1 and when exiting device 1 is represented schematically in FIG. 2.

In detail, device 1 consists of a plurality of modules 4.1-4.n arranged immediately contiguously in transport direction A. In the depicted embodiment, all eight modules 4.1-4.8 are formed of an identical base unit 5 that is equipped with the functional elements necessary for the special task of respective modules 4.1-4.8.

Each base unit 5 comprises a drive and control unit accommodated in a module housing 6 and a transport and treatment element 7, 7a that is arranged on the top of module housing 6 and that can be driven by the drive and control unit to rotate about a vertical machine axis of respective module 4.1-4.8, and that has a plurality of holders 8 that are provided distributed at equal angular distances about the periphery of transport and treatment element 7 or 7a and of which each mounting 8 is configured to reliably pick up one packaging element 2.

Transport and treatment elements 7, 7a of individual modules 4.1-8.1 are arranged immediately or for transport purposes adjacent to one another, and driven in counter rotation but synchronously such that these transport and treatment elements 7, 7a, in their totality, form a transport device by which packages 2 are moved within device 1 on the multiply deviated packaging element transport path 3 shown in FIG. 3 between package inlet 1.1 and package outlet 1.2. Individual packages 2 are each transferred directly from transport and treatment element 7 of one module 4.1-4.7 to transport and treatment element 7 of the module 4.2-4.8 that follows in transport direction A.

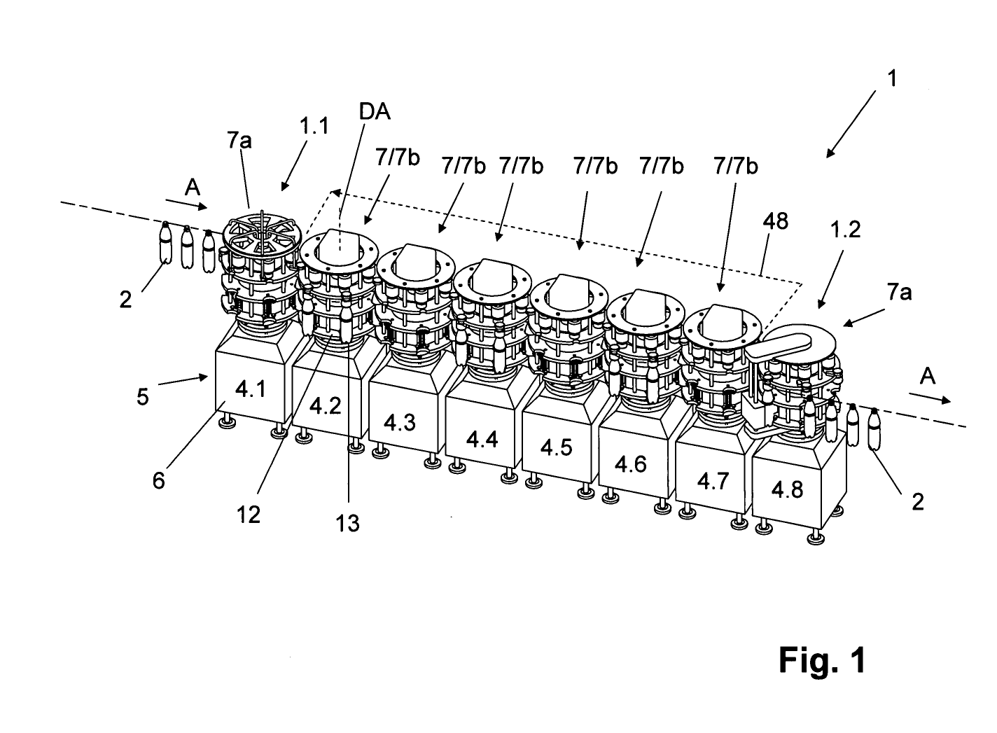

In the representation in FIGS. 1 and 2, transport and treatment element 7 of module 4.1, which is the first relative to transport direction A, is driven synchronously clockwise, transport and treatment element 7 of the next-following module 4.2 counter clockwise, transport and treatment element of the next-following module 4.3 again clockwise and so forth. The synchronization of the individual modules 4.1-4.8 is effected by a suitable controller.

In the embodiment shown in the figures, individual modules 4.1-4.8 are again provided sequentially such that the vertical machine axes of all modules 4.1-4.8 lie in a common vertical plane. Also located in this plane are the transfer regions where packages 2 are transferred from transport and treatment element 7a or 7 of one module 4.1-4.7 to transport and treatment element 7 or 7a respectively of module 4.2-4.8 that follows in transport direction A.

The basic and also known function of individual modules 4.1-4.8 is for example as follows:

Module 4.1 constitutes the inlet module or package inlet 1.1 of device 1. In module 4.1, however, a pretreatment is also preferably carried out of packages 2, at least in the region of the packaging element that is to be printed. Examples of pretreatment include plasma or corona treatment, which is practicable if the application of the multiple-pass print in the subsequent modules is effected with the use of print stations or print heads in those modules and which operate according to the known inkjet print head principle or so-called Tonejet principle. The pressurizing of the packaging element 2 is also advantageously effected in module 4.1.

Modules 4.2-4.5 following module 4.1 constitute the actual print modules in which the multiple-pass print is effected, preferentially as color print in the form that one color set of the color print is printed at each of the modules 4.2-4.5, for example in yellow, magenta, cyan and black. Holders 8 that are located there therefore constitute handling or printing positions.

Module 4.6, which then follows in transport direction A, is configured as a drying module in which the respective previously generated multiple-pass print is finally dried in a suitable manner, for example by the application of energy e.g. by heat and/or by UV radiation.

Module 4.7 is configured as an inspection module to which each packaging element 2 passes after the drying of the multiple-pass print and in which the multiple-pass print concerned is examined for possible errors such that incorrectly printed packages 2 can be separated out at module 4.7 or subsequently on the onward transport path.

Finally, module 4.8 constitutes an outlet module or package outlet 1.1 of device 1, at which the fully printed packages 2 leave the device 1. Module 4.8 is preferentially also configured as a drying module.

As FIG. 3 shows, packages 2 are each moved with transport and treatment elements 7 of modules 4.1 and 4.8 over an angular range of approximately 90° about a vertical machine axis MA of modules 4.1 and 4.8. In the case of the other modules 4.2-4.7, packages 2 are each entrained by respective transport and treatment element 7 over an angular range of 180° about the vertical machine axis of modules 4.2-4.7. The process that is assigned to the respective module is carried out in modules 4.2-4.7, within this angular range or within this path of the rotational motion of respective transport and treatment element 7.

In greater detail, modules 4.1-4.n, but at least modules 4.2-4.7, which are used for the printing of packages 2, or circulating transport and treatment element 7 of these modules, include printing segments 11 that are each mounted interchangeably as complete functional assembly units on a rotor 12 driven to rotate about respective vertical machine axis MA, with that rotor being mounted so as to rotate about vertical machine axis MA on module housing 6 or on a central pillar 13.

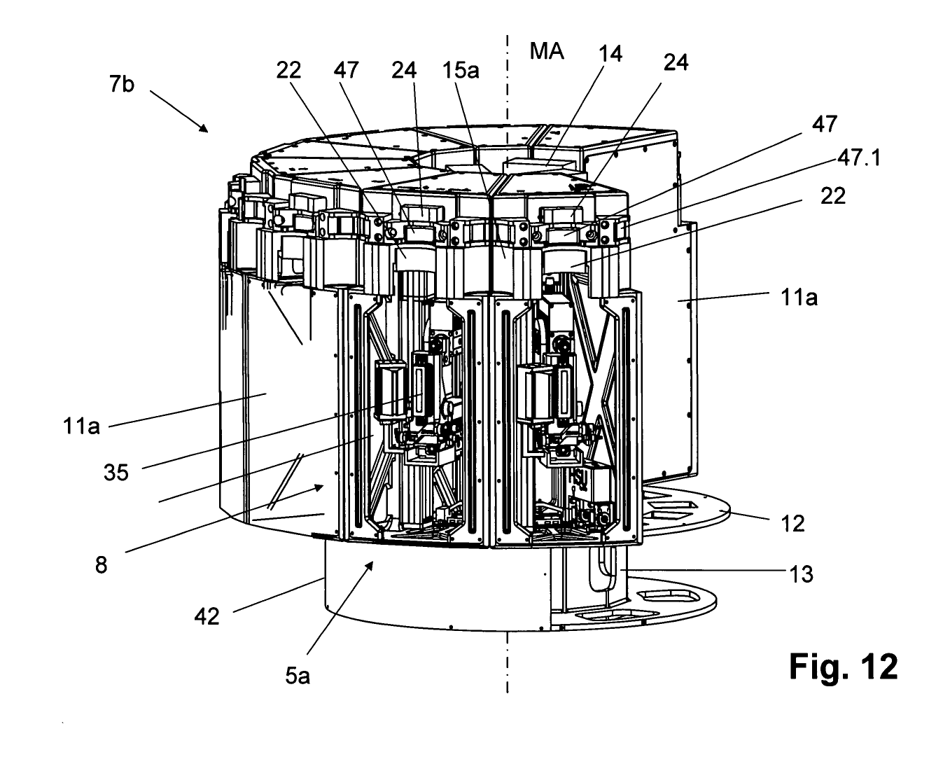

Printing segments 11 are provided on the periphery of rotor 12 adjacent to one another in peripheral direction of rotor 12 and are configured like wedges when seen in plan view. These printing segments 11 define a space in the region of machine axis MA that is enclosed by printing segments 11 and in which are accommodated a plurality of functional elements, such as electronic control elements or computers 14, as shown in FIG. 12, for triggering printing segments 11.

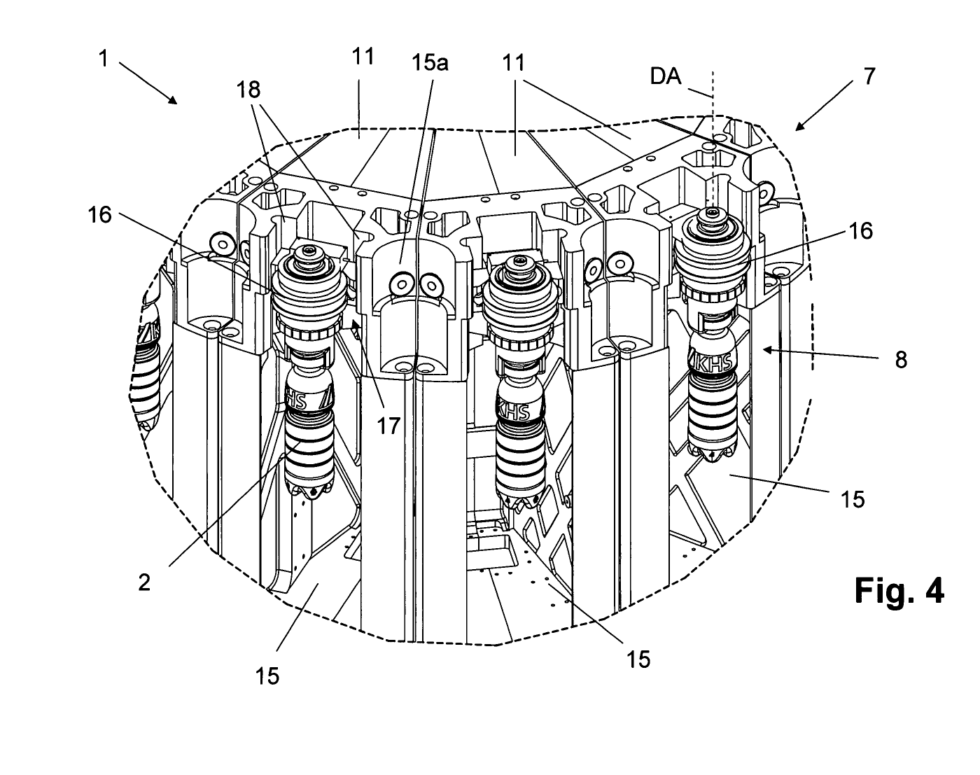

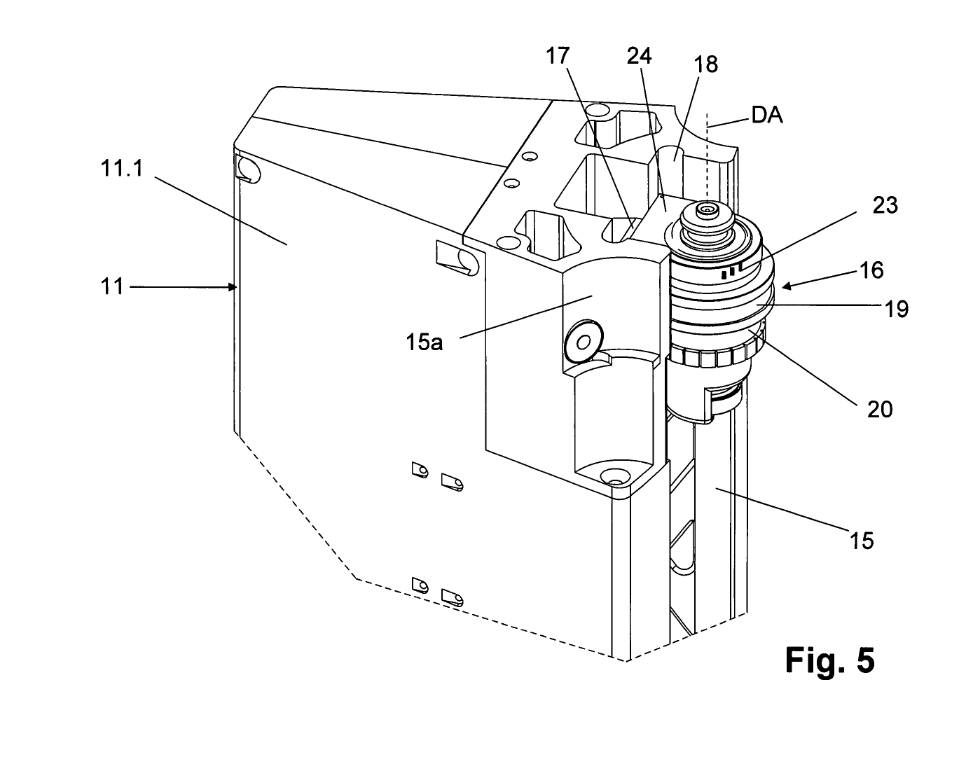

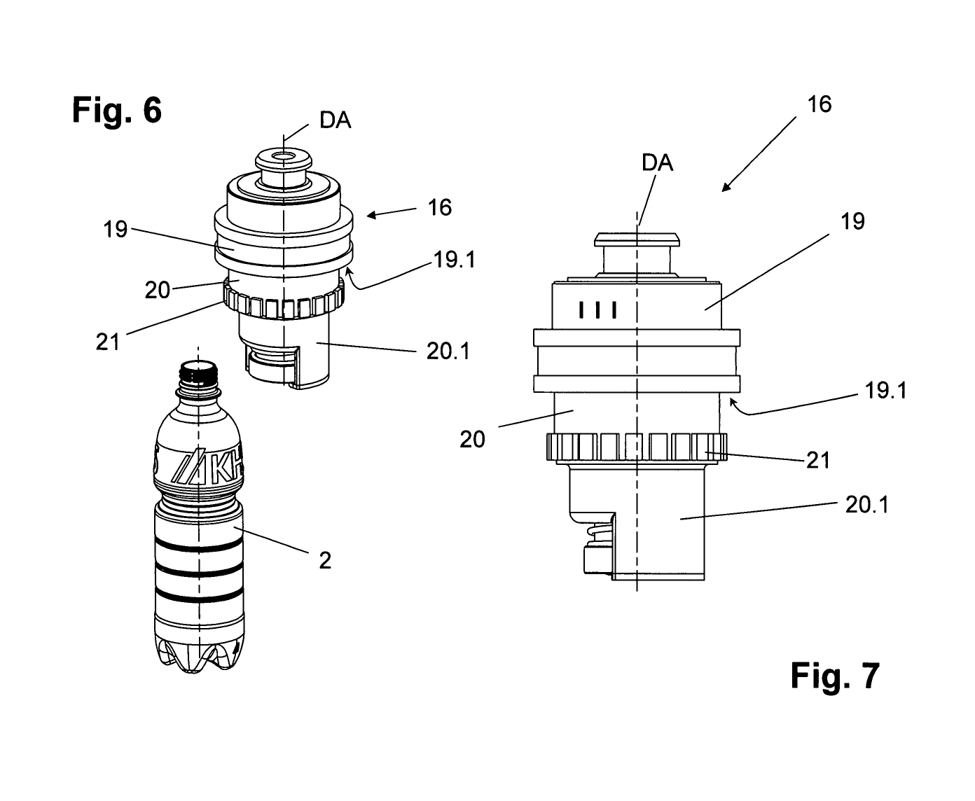

Each printing segments 11 forms, on its side that is radially outward relative to the machine axis MA, a recess 15, as seen in FIG. 4 and FIG. 5. During handling, packages 2 are received in this recess at least by a part of their package body while suspended from holding-and-centering units 16 in the region of their package top or package opening, i.e. with the package oriented vertically and parallel to machine axis MA and to a printing-segment axis DA. In the region of mounting or recess 15, each printing segment 11 exhibits at least one print head and any other functional elements required to print on packages 2.

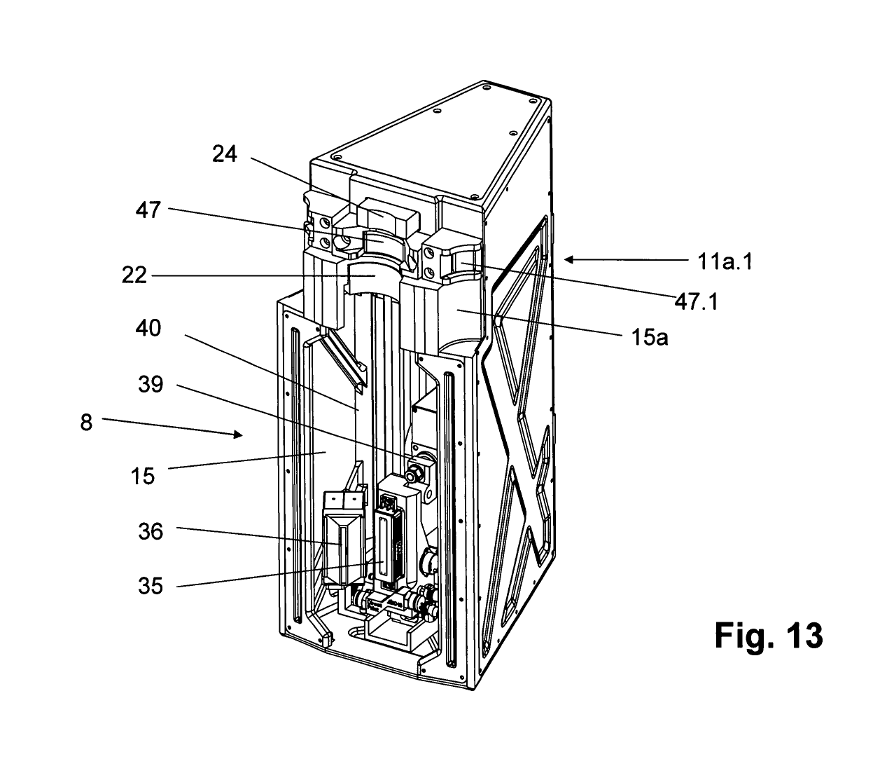

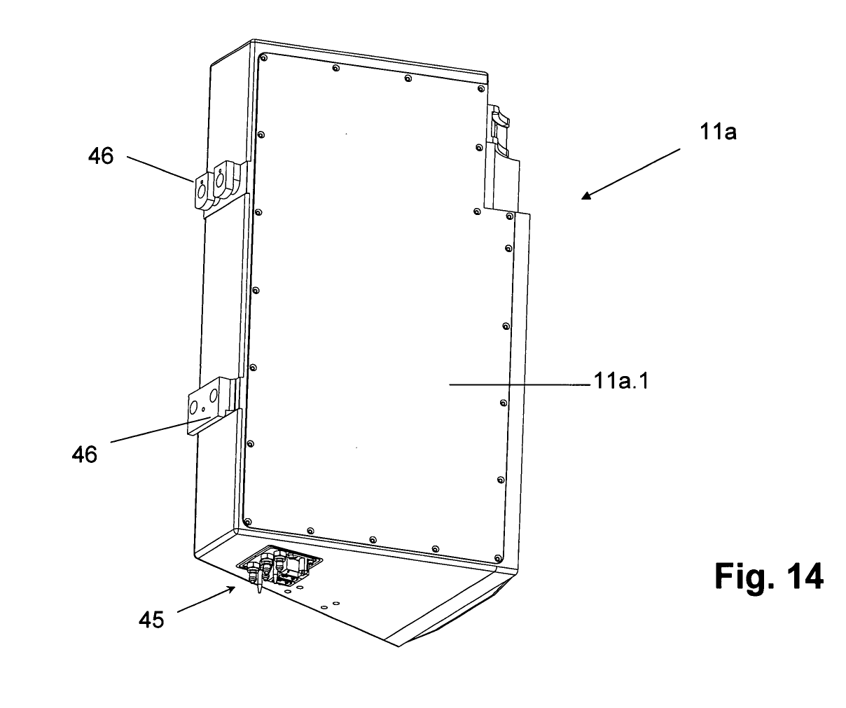

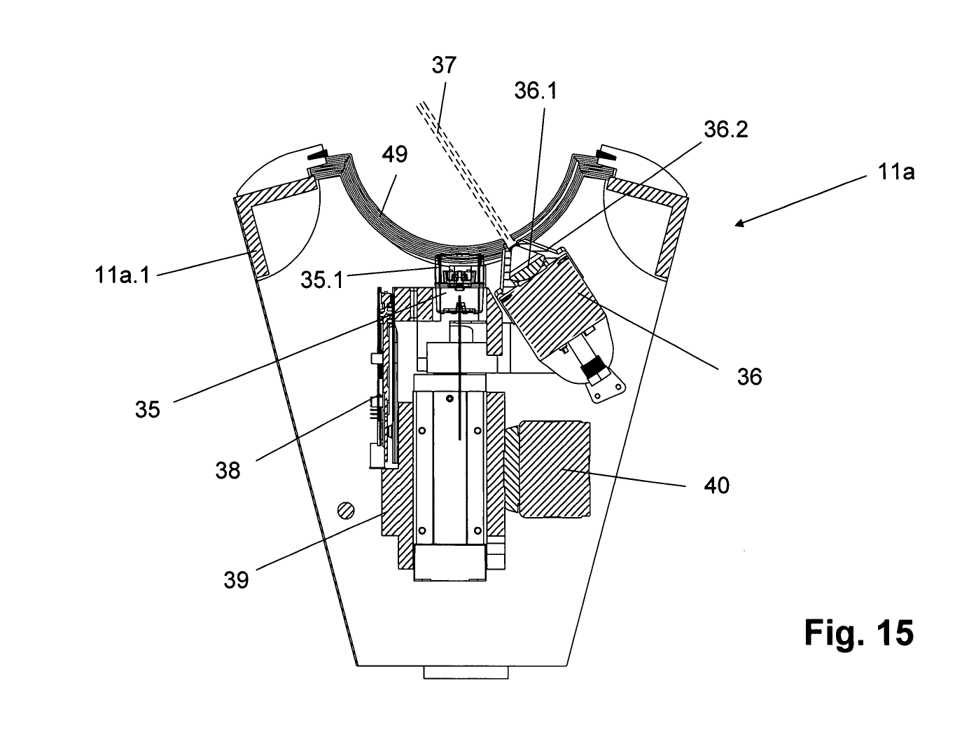

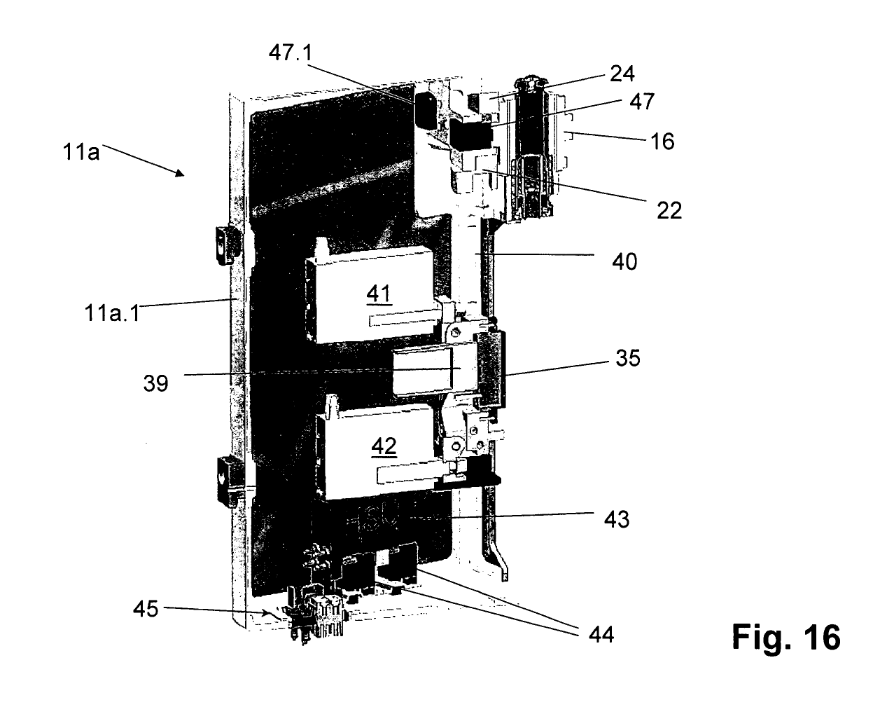

Holding-and-centering units 16 are in turn each held on a carrier 17 that is fastened in associated lateral slots 18. Optionally, the carrier 17 can be traversed or displaced, like a carriage, in slots 18, or driven by a motor if applicable, as shown in FIG. 5. In case of the alternative depicted in FIG. 13, carrier 17 is not configured in that form, but all elements or functions are directly integrated into printing segment 11, 11a.

During handling and/or printing of packages 2, holding-and-centering units 16 cause either alignment, and controlled rotation, and/or pivoting of packages 2 about their vertical packaging element axes, which are disposed on the same axis as the printing-segment axis DA. Each holding-and-centering unit includes a primary part 19 that is held on respective carrier 17, and a secondary part 20.

The primary part 19 secures and aligns the holding-and-centering unit 16 on carrier 17 or on holder 8 or on printing segment 11. For this purpose, the primary part 19 includes a reference face 19.1 whose complementary counterpart in the printing segment 11 serves as a reference plane or reference face for locating and hence for adjustment relative to the print head. This creates a fixed common reference between the holding-and-centering unit 16 or packages 2 and the respective print head or print heads.

The secondary part 20 suspends the packaging element 2. The secondary part 20 is configured like a gripper. Embodiments include a mechanical gripper, a pneumatically actuated gripper, and/or a vacuum gripper. Preferably, in a respective printing segment 11, the required holding force is passively applied to the primary part 19 and actively removed or released, for example by way of one or a plurality of permanent magnets, so as to increase safety in the absence of flow or media.

The secondary part 20 includes the active components. These are the components needed for aligning, controlled rotating, and/or pivoting of packages 2 during handling, and/or elements for supplying compressed air and/or vacuum etc.

The secondary part 20 is mounted in primary part 19 so as to be able to rotate or pivot about printing-segment axis DA. In the illustrated embodiment, the secondary part 20 includes the rotor of an electric positioning or angular drive for the aligning and controlled rotating or pivoting of packages 2 during handling.

The secondary part 20 also includes a permanent magnet array 21 that has a plurality of permanent magnets. In a peripheral direction, the permanent magnet array 21 exhibits alternately north and south poles. The array 21 interacts with a solenoid array 22 that is provided on the carrier 17 and that forms the stator of a positioning drive or electromagnetic direct drive.

A coding 23 is provided on the primary part 19. The coding 23 interacts with an incremental sensor 24 provided on carrier 17. Together, these define an encoder system that determines the respective random orientation of primary part 19, and hence an orientation of the holding-and-centering unit 16. This orientation, which is determined by the encoder system, can then be taken into account during the aligning and controlled rotating of packages 2 during printing, is then effected taking account of this orientation as determined by the encoder system and taking account of the association. Handling occurs solely by rotating the secondary part 20 and without rotating the primary part 19. The incremental sensor 24 is static relative to the rotor 12 or pillar 13 and rotates with the rotor 12 or pillar 13. The aligning and controlled rotating of packages 2 about printing-segment axis DA is effected relative to respective printing segment 11 or relative to functional elements located there, such as print heads.

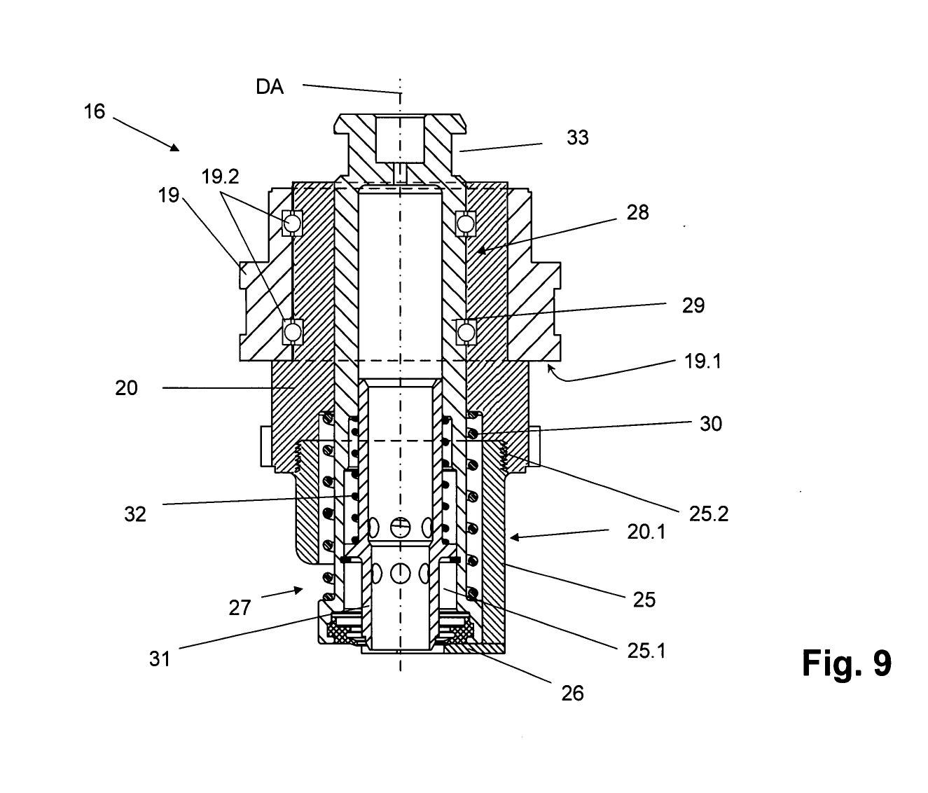

FIG. 9 shows an embodiment of holding-and-centering unit 16 in section and in an idle position without packages. As depicted, the holding-and-centering unit 16 has a ring-like primary part 19 and a sleeve-like secondary part 20 that is mounted in the primary part 19 so as to be able to rotate about the printing-segment axis DA and that projects with its lower length beyond the underside of the primary part 19 where it is configured with a mounting-and-base part 20.1.

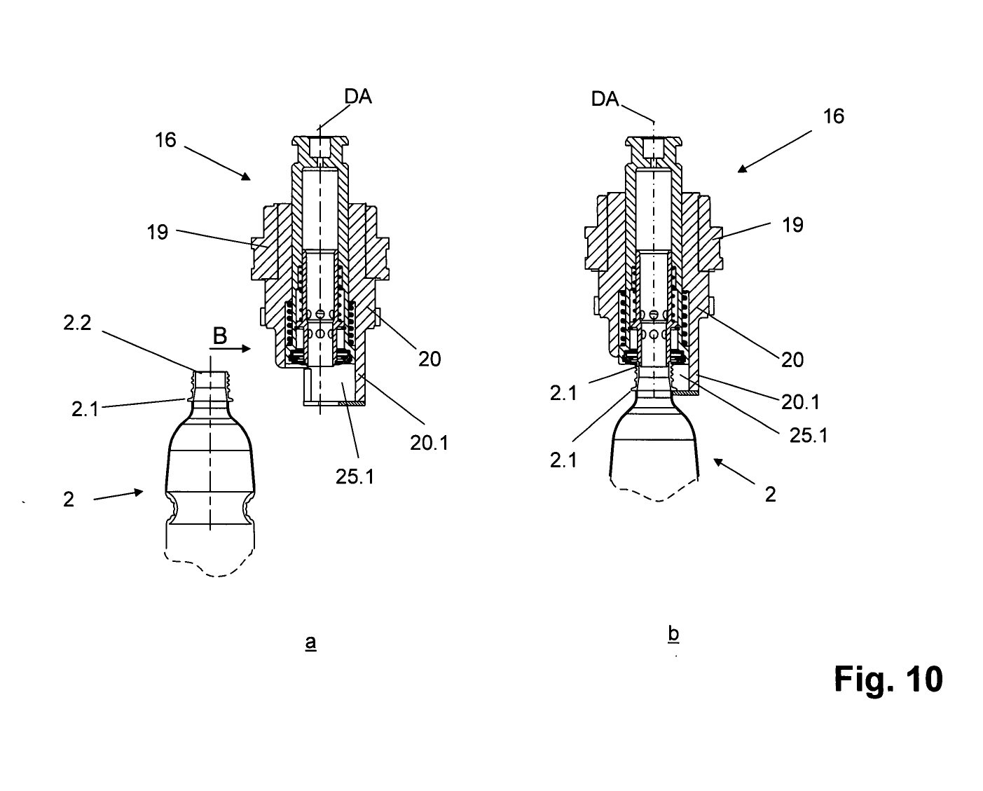

Bearings 19.2 can include a bearing sleeve, needle bearing, or an equivalent structure. This is adapted to the type, shape and size etc. of packages 2 and is part of a gripper for the holding of empty packages 2. Specifically, mounting-and-base part 20.1 has a sleeve 25 arranged with its axis on the same axis as the printing-segment axis DA, and a carrier plate 26 at the lower open end of the sleeve 25. The mounting-and-base part 20.1 can be separated from the upper section of the sleeve 25 by a thread 25.2. A bayonet closure, clamp or other mechanism could also be selected as an alternative to the thread 25.2. The sleeve 25 has a lateral opening 27. According to position (a) in FIG. 10, a package 2, which in the drawing is a bottle, is introduced through this opening 27 into the mounting-and-base part 20.1 (arrow B). According to position b in FIG. 10, the bottle can be fixed to the mounting-and-base part 20.1 in such a way that the package 2 is held on the carrier plate 26 suspended by a mouth edge 2.1.

In the secondary part 20, a centering-and-holding element 28 is arranged to be axially displaceable relative to the printing-segment axis DA. The centering-and-holding element 28 includes an outer sleeve body 29 that is preloaded by way of a compression spring 30 in a lower position. The sleeve body 29 lies with its lower end face against the carrier plate 26. When the package 2 is a bottle held at a holding-and-centering unit 16, the sleeve lies against the upper side of the package 2, which faces away from the carrier plate 26 or against the mouth edge 2.2 of the package 2 located there. As a result, the package 2 is clamped firmly, and in particular, cannot rotate, as a result of the force of the compression spring 30 between the sleeve body 29 and the carrier plate 26. A centering sleeve 31 that is also arranged on the same axis as the printing-segment axis DA is provided in the sleeve body 29 so as to be axially displaceable. The centering sleeve 31 is also preloaded by a compression spring 32 in a lower position.

In order to receive a packaging element 2 or bottle, the centering-and-holding element 29, which includes a sleeve body 29, a first compression spring 30, a centering sleeve 31, and a second compression spring 32, is raised against the action of the first compression spring 30 (step 1) by a lifting element that engages behind a collar or an annular slot 33 of the sleeve body 29 and that is provided at least on package inlet 1.1 and package outlet 1.2, as shown in FIG. 10a.

After the introduction of the packaging element into the holding-and-centering unit 16 (FIG. 10b), centering-and-holding element 28 is lowered by the action of the compression springs 30, 32 and thereby centered and positioned in the mounting-and-base part 20.1 (step 2) and subsequently fastened passively, i.e. by clamping (step 3).

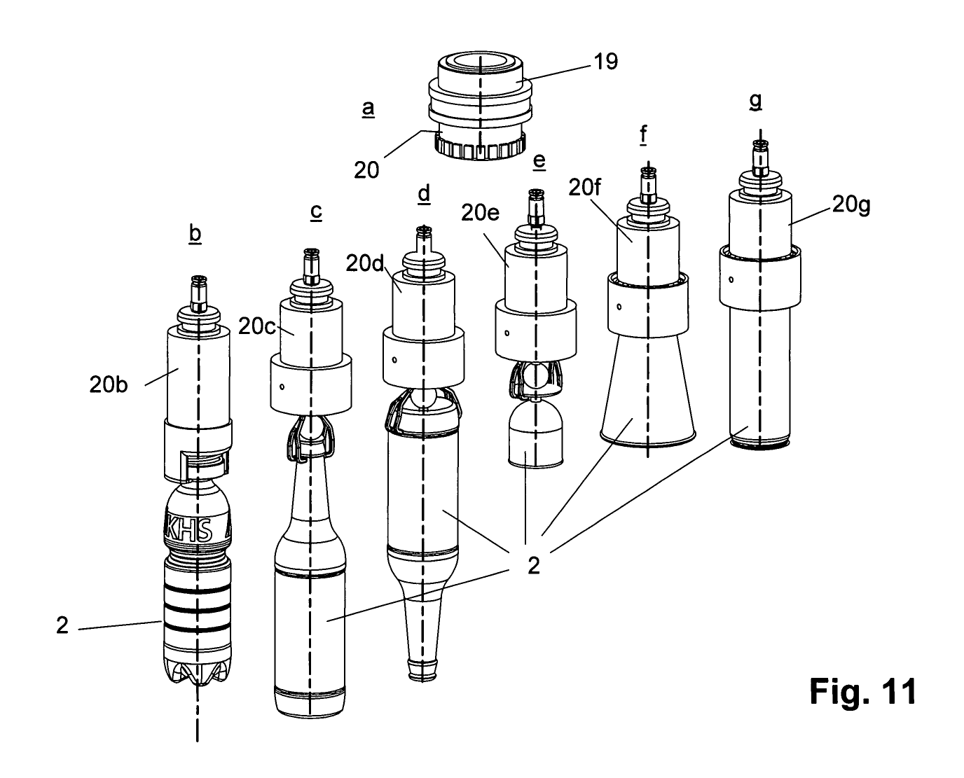

In the process, package 2 is centered with centering sleeve 31 or with its lower outwardly tapered end in such a way that the package axis is then arranged on the same axis as the printing-segment axis DA. As shown in FIGS. 9 and 10, packages 2, which can be bottles, are printed upon while in they are empty. The concentrically arranged compression springs 30 and 32 and the guides and supports that can be pushed into one another are coupled in such a way that, in step 2, a weak spring force first acts on the container mouth so that a slight movement of the package 2 on the carrier plate 26 can take place. A final holding force is applied in step 3 to achieve a gas-tight condition, as shown in FIG. 11. FIGS. 10 and 11 in turn show an alternative embodiment in which the mounting-and-base part 20.1 is not detachable or is made of a single piece.

In the case of alternative embodiments, other equivalent drives are conceivable for the clamping of the packages. These equivalent drives include, for example, pneumatically or electrically driven gripping and/or clamping elements.

Packages 2 are picked up in a protected manner by their mouth region between mouth flange 2.1 and mouth edge 2.2 in the interior 25.1 of the sleeve 25. In particular, with a very hygienic variant, it is an advantage to configure holding-and-centering units 16 or their secondary parts 20 in such a way that the mouth 2.2 of a package 2, and nearby structures such as the mouth region and a thread located in the mouth regions, are all protected from dirt and ink spray during the printing operation.

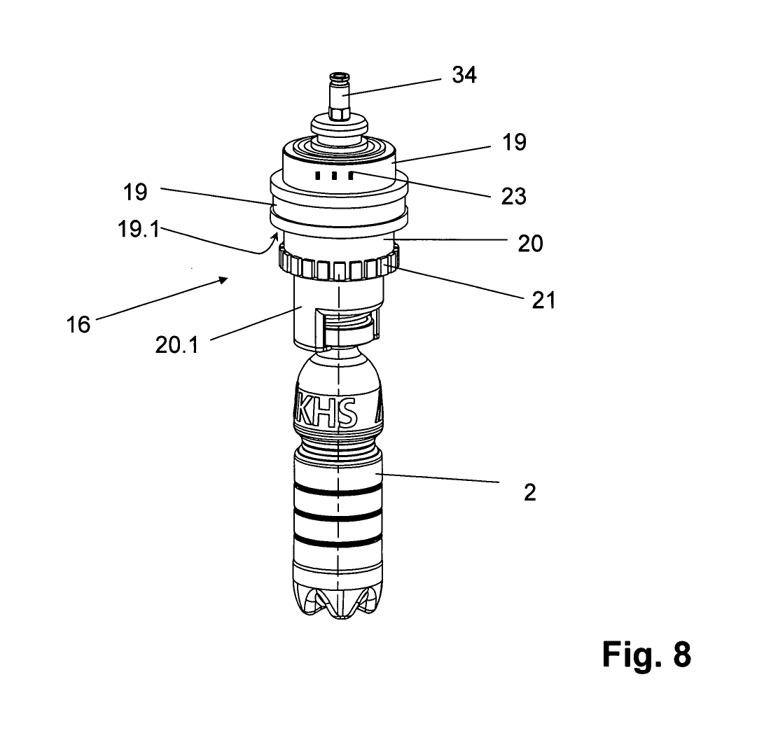

In order to stabilize the still-empty packages 2, it is expedient to fill them with a pressure medium, such as a pressurized gaseous and/or vaporous medium, for example with compressed air. This filling occurs during or after the packages 2 are fixed to their respective holding-and-centering units 16. As shown in FIG. 8, a quick-acting coupling 34 for connection to a source (not shown) supplying the pressurized medium is provided for this purpose at a respective holding-and-centering unit or at its centering and holding element 28. The internal pressure in the package 2 can continue to be controlled by this quick-acting coupling 34, by a line (also not shown) in the interior of the respective holding-and-centering unit 16, and by a gas outlet. Ideally the internal pressure is held constant over the entire transport path. As can be seen from FIG. 9, holding-and-centering unit 16 is made hollow for this purpose, with the central inner cavity forming a line 29.1 through which a vaporous or gaseous medium can be passed into the interior of the package 2.

The secondary part 20 is preferentially configured in such a way that a format-dependent mounting-and-base part 20.1 is detachably connected with the secondary part 20 so that, for the processing of packages 2 of different types, shapes, and/or sizes, mounting-and-base parts 20.1 on holding-and-centering units 16 can simply be exchanged for suitably matching ones. Mounting-and-base parts 20.1 that are adapted to suit the type, shape, and/or size of packages 2 that are to be handled are then connected with the secondary part 20 in a torsion-proof manner, for example with the help of a quick-change mechanism, a quick-acting coupling, a screw fastener, and/or a clamp-fastener.

FIG. 11 again shows, in position (a), a primary part 19 of a holding-and-centering unit 16 in single view, and in positions (b)-(g), different secondary parts 20b-20g for different packages 2. These secondary parts are formed at least in part by different mounting-and-base parts 20.1. In the case of the depicted embodiments, secondary parts 20b-20e are again each executed as mechanical grippers, operable for example by compressed air, provided for holding packages 2b-2c and 2e by their respective package tops or in the region of their respective package openings, or for holding packages 2d by a package underside. Secondary parts 20f and 20g are executed as vacuum grippers for holding packages 2f and 2g by vacuum by their respective package tops or in the region of their respective package openings.

Holding-and-centering units 16, and preferably secondary parts 20 of these units, are in turn provided with a unique identification facility, preferably with a with an RFID code that identifies the respective holding-and-centering unit 16. The RFID code can include information about the unit's type and/or information about the particular secondary part 20. The corresponding information can then be read out by at least one reading unit of device 1 and/or of respective print module 4.1-4.n, for example for monitoring or inspection purposes.

FIG. 12 depicts a transport-and-treatment element 7b that can be used in the device 1 instead of transport-and-treatment elements 7. The transport-and-treatment element 7b differs from transport-and-treatment elements 7 essentially in that the printing segments 11a that form transport-and-treatment elements 7b do not have the height-adjustable or displaceable carrier 17. Instead, the holding-and-centering units 16 are held directly, i.e. not height-adjustably, on respective printing segment 11a. Accordingly, incremental sensor 24 and solenoid array 22 are also provided on the printing segment 11a or on its housing 11a.1.

Printing segments 11a are again provided adjacent to one another on the rotor 12, which in turn is mounted on the pillar 13 of the base unit 5a that corresponds to the base unit 5 so as to be rotatable and drivable about the vertical machine axis MA.

In the interior of its segmented housing 11a.1, each printing segment 11a has the functional segments needed for printing packages 2. These include, for example, at least one inkjet print head 35 having electronically controllable discharge jets, for printing color or printing ink and other media, that are arranged in at least one row parallel to the printing-segment axis DA. A drying device 36 for the immediate drying of the printing color or corresponding printed image applied to packaging element 2 is associated with each print head 35. In the depicted embodiment, the drying device 36 is an infrared and/or UV emitter discharging a linear field of UV and/or infrared radiation 37 that covers at least the entire printed image applied with print head 35. The drying device 36 is offset by some angle against print head 35 relative to the printing-segment axis DA. During printing of a package 2, the print head is subjected to a controlled rotation about the printing-segment axis DA in such a way that the printing color applied with the print head 35 is dried or at least largely dried with the UV and/or infrared radiation 37 immediately following application.

In a way not otherwise represented, drying device 36 is cooled, for example using air and/or water as the cooling medium.

The print head 35, the drying device 36, as well as electronics 38 configured at least as a driver stage for the print head 35, are all provided on a common carriage 39 that is adjustably guided in the direction of the printing-segment axis DA on a pillar 40 by way of a positioning drive 41. In the depicted embodiment, by way of a positioning or angular drive 42 that is provided on carriage 39, print head 35 and drying device 36 can again be adjusted by pivoting, preferably by pivoting about at least one axis that is square to the printing-segment axis DA and tangential to the periphery of transport and treatment element 7b as formed by the printing segments 11a. As a result, the position of the print head 35 can be matched to the position of the packaging element surface that is to be printed such that the jet openings of the print head 35 are as close as possible to the package's surface and so that the centerlines of the jet openings are square as possible relative to the package surface that is to be printed upon.

To avoid fouling of the printing segment 11a by sprayed ink, respective print head 35 is configured with a protective element 35.1. The protective element 35 can be blade-like, scale-like and/or rubber-ball-like. During printing, the protective element 35.1 lies against the package 2 being printed upon to outwardly limit the printed space.

To configure the bundled linear infrared beam 37, the drying device 36 is executed with an optical beam forming element 36.1 in the form of a cylinder lens and with a protective and guiding aperture 36.2.

Accommodated in the interior of housing 11a.1 are other functional elements of the printing segment 11. These include a pressure balancing tank 43 for the colored ink, pumps 44 for feeding ink and for removing surplus ink, as well as other functional elements that are not depicted, such as electronic control elements for the controlling of the respective printing segment 11 and the controlling of drives 41 and 42 etc. The underside of the housing 11a.1 is provided with a coupling unit 45 by which all necessary electrical connections (in particular also for drives and controlling and monitoring data) and all fluid connections (for cooling functional elements and for feeding ink) can be made by plugging into a matching coupling unit (coupling panel) provided on the rotor 12.

On the narrow rear side, which lies radially inward relative to machine axis MA, mechanical holding-and-centering elements 46 are provided on the housing 11a.1 of each printing segment 11a. With these holding-and-centering elements 46, a secure and exact connecting of the print module 11a with the rotor 12 or with a rotor element concentrically surrounding machine axis MA is at least partially possible by plugging in the printing segment 11a.

An aperture-like wall 49 is provided on the inside of the recess or mounting 15. The aperture-like wall 49 closes off the interior space of housing 11 except for openings for the carrier 17, the print head 35 and UV and/or infrared drying unit 36.

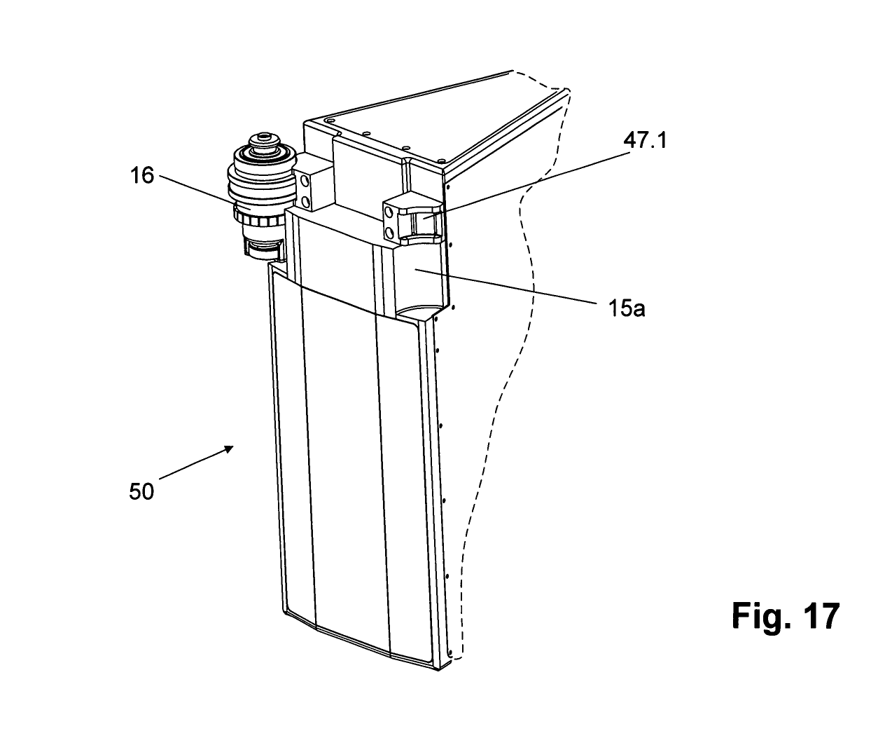

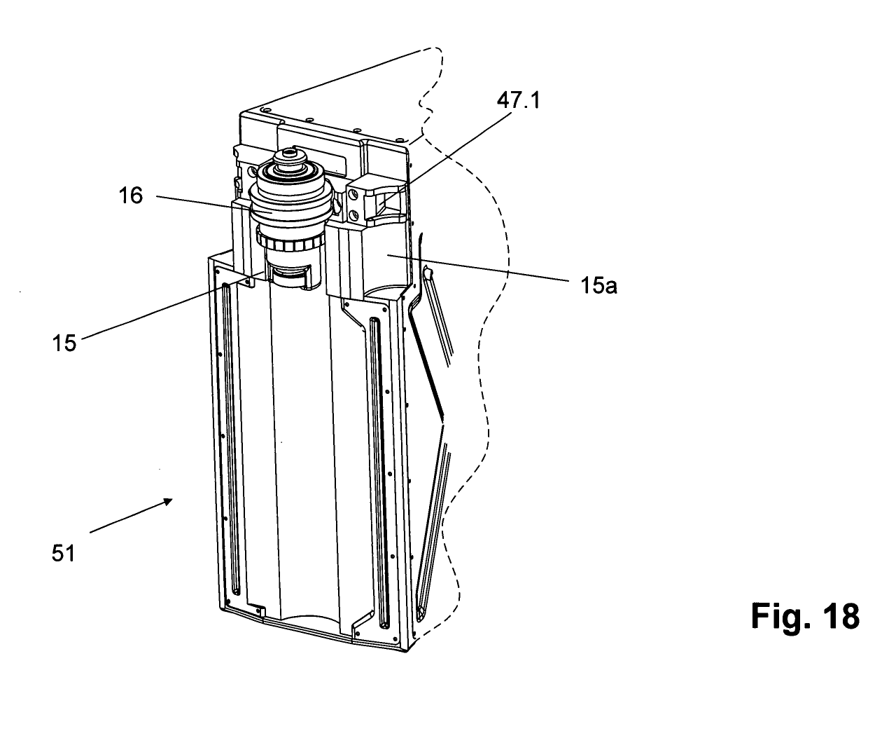

It has been assumed above that the holding-and-centering units 16 are part of individual modules 4.1-4.n or printing segments 11 and 11a. In a preferred embodiment of the invention however, holding-and-centering units 16 are pucks that pick up respective packages 2 at the package inlet 1.1 and only release the packages 2 again at the package outlet 1.2. This means that each package 2 is held constantly on one and the same holding-and-centering unit 16 on the transport path 3 between package inlet 1.1 and the package outlet 1.2. In the course of traversing the transport path 3, the holding-and-centering unit is passed on from a transport-and-treatment element 7, 7a, 7b or from a mounting 15 located there to a transport-and-treatment element 7, 7a, 7b following in transport direction A or to a mounting 15 located there. Mechanisms for holding and releasing the holding-and-centering units 16 are provided on the carriers 17 of the printing segments 11 or on the printing segments 11a for this purpose. FIG. 17 shows one example in the form of a radially projecting holding ring that interacts with or is held by controlled solenoids 47. Other gripper-like mounting, holding and/or transfer elements can also be used.

From the package outlet 1.2, the holding-and-centering units 16 are returned on a puck transport path to the package inlet 1.1. This puck transport path, which is schematically and/or functionally suggested in FIG. 1 by the broken line 48, is constituted by autonomous transport-and-treatment elements or by transport-and-treatment elements 7. In the latter case, an additional mounting 15a is then provided between two recesses 15 for the mounting of a holding-and-centering unit 16 (FIGS. 4 and 12). In the case of the depicted embodiments, this is formed by corresponding concave vaults in the face of each of two printing segments, such as printing segments 11, 11a or their respective housings 11.1, 11a.1. These additional recesses 15a for the empty holding-and-centering units 16 that are to be returned are thus each formed from two part-recesses and are, in the depicted example, on the same level as the receptacles 15. Additional recesses 15a also exhibit holding magnets and solenoids 47.1, with a holding magnet and solenoid 47.1, also executed as a permanent magnet if necessary, being provided at least in every second, and ideally in both part-receptacles.

FIGS. 17 and 18 show two different dummy segments 50, 51 that match, or that have housings that match the shape, size, or dimension of the printing segments 11a and that essentially differs from the printing segments 11a only because they do not exhibit all of the functional elements needed for the printing of packages 2.

The dummy segments 50, 51b are arranged on transport and treatment elements 7b between printing segments 11a in order to reduce the number of handling positions 8 formed by printing segments 11a on transport and treatment elements 7b if, for example, only a reduced throughput (number of packages 2 handled per unit of time) is required for the corresponding device 1. The dummy segments 50, 51 can also be used to return holding-and-centering units 16, which are configured as pucks, from the package outlet 1.2 to the package inlet 1.1, with holding-and-centering units 16 being held either at the receptacles 15 or at regions of the dummy segments 50, 51 that correspond to receptacles 15a.

FIG. 12 shows an annular tank 42 surrounding the pillar 13. The annular tank 42 receives ink of the respective printing color. It is provided, for example, on the base unit 5a and is connected by a rotary connection with pressure balancing tanks 43 and/or with pumps 44 located at the pressure balancing tanks 43.

Among the advantages of the are that the relationship of packages 2 to the basic machine or device 1 is decoupled, i.e. in particular holding-and-centering units 16, including in their configuration as puck, can be adapted to different shapes, sizes, etc. of packages 2 and that in particular a height adjustment of carriers 17 and/or of carriages 39 carrying print heads 35 is also possible for adapting to the different shapes, sizes, and forms of packages 2.

Another advantage of the invention is that printing segments 11 and 11a are configured as fully functional assembly units or modules. This means that not only is the assembly of the respective device 1 simplified, but it is also possible to replace, for example, faulty printing segments 11 or 11a and to repair such printing segments 11 or 11a outside the device 1.

Yet another advantage is simplification of stock-keeping by the manufacturer of the device 1.

Yet another advantage is that the use of dummy segments 50 and 51 makes it possible to adapt device 1 to a reduced throughput.

Another advantage is that structurally identical base units 5 can be used with structurally identical printing segments 11 to realize the device 1. This generally results in a compact design for the device 1.

The invention has been described hereinbefore by reference to embodiments. It goes without saying that numerous variations as well as modifications are possible, in particular including in regard to holding-and-centering units 16, printing segments 11, 11a and the device as a whole, without departing from the inventive concept underlying the invention. So, for example, instead of coding 23 on the primary part 19, this coding can be provided on the part 20, or on both to then together constitute, with an incremental sensor disposed on the printing segment 11 or 11a, an encoder system for the aligning and/or controlled rotating of packages 2.

The invention has also been described hereinbefore in the context of packages 2 that are bottles. The inventive device, its holding-and-centering units, and its printing segments are however also suited to the applying of a furnishing, for example of a print or multiple-pass print, also polychrome print, onto other containers or packages.

### LIST OF REFERENCE CHARACTERS

1 Device
1.1 Package inlet
1.2 Package outlet
2 Packages or bottles
2.1 Mouth flange
2.2 Packaging element mouth or bottle mouth
3 Route of the packaging element transport path
4.1-4.n Module
5, 5a Base unit
6 Module housing
7 Transport and treatment element
8 Holder
9, 10 Section of the transport path
11, 11a Printing segment
12 Rotor
13 Pillar
14 Electronics
15, 15a Recess
16 Holding-and-centering unit
17 Carrier or puck carrier
18 Slot
19 Primary part
19.1 Reference face
19.2 Bearing
20 Secondary part
20.1 Mounting-and-base part
21 Permanent magnet array
22 Solenoid array
23 Coding
24 Incremental sensor
25 Sleeve
25.1 Interior space
25.2 Thread
26 Carrier plate
27 Opening
28 Centering element
29 Sleeve body
29.1 Line
30 Compression spring
31 Centering sleeve
32 Compression spring
33 Annular slot
34 Quick-acting coupling
35 Print Head
36 Infrared device
36.1 Beam forming element
36.2 Protective and guiding aperture
37 Infrared beam
38 Electronics
39 Carriage
40 Pillar
41,42 Drive
43 Pressure balancing tank
44 Pump
45 Coupling unit
46 Mechanical holding-and-centering element
47 Holding magnet or solenoid
47.1 Holding magnet or solenoid in recess 15, 15a
48 Transport path
49 Wall
50,51 Dummy segment
A Transport direction
B Movement of packages 2 during the connection with a holding-and-centering unit
DA Axis of the printing segment 11
MA Machine axis

1-28. (canceled)

29. An apparatus for treating packages by applying furnishing features to said packages, said apparatus comprising a plurality of holding-and-centering units, each of which comprises a primary part and a secondary part, wherein said primary part is held at a holding position during package handling, wherein said secondary part is mounted on or in said primary part so as to be rotatable about a vertical axis of said holding-and-centering unit, wherein said secondary part receives a functional element necessary for handling a package, wherein said secondary part is driven by a motor during handling of a package, wherein a plurality of secondary parts adapted to different types, forms and/or sizes of packages are associated with said primary parts, wherein handling packages comprises at least one of holding, centering, aligning, moving, rotating, and pivoting a package at said holding positions, and wherein said features comprise printed material having plural colors.

30. The apparatus of claim 29, further comprising a package inlet, a package outlet, and a package transport path on which packages are moved in a transport direction from said package inlet to said package outlet, wherein said package transport path comprises at least one transport-and-treatment element that can be driven to rotate about a vertical machine axis, and wherein said transport-and-treatment element comprises a plurality of holding positions, each of which comprises one of said holding-and-centering units for handling packages.

31. The apparatus of claim 30, wherein said secondary part comprises an electromagnetic direct drive for controlled handling of a package, wherein said electromagnetic direct drive comprises a rotor and a stationary structure, wherein said stationary structure is one of a stator and a solenoid array, wherein said rotor comprises an array of permanent magnets that interact with said stationary structure, and wherein controlled handling is selected from the group consisting of aligning a package and rotating a package.

32. The apparatus of claim 30, wherein said secondary part comprises a format-adapted interchangeable mounting, a base part, and an infinitely variable and controllable electric motor, and wherein said primary part comprises a motor housing of said infinitely variable and controllable motor.

33. The apparatus of claim 30, further comprising functional elements, wherein said functional elements comprise all functional elements necessary for the aligning and/or controlled moving of a package during handling thereof, wherein said functional elements are provided on a respective secondary part.

34. The apparatus of claim 30, wherein at least one of said primary part and said secondary part comprises a coding, and a sensor, wherein said coding indicates rotational angle position to said sensor.

35. The apparatus of claim 30, further comprising a sensor, wherein said primary part comprises a structure for enabling definition of a rotational angle position of said primary part relative to a respective holding position, wherein said sensor is configured to detect said rotational angle position, and wherein said structure is selected from the group consisting of a form-fitting mounting, and centering-or-coupling elements.

36. The apparatus of claim 30, wherein said package transport path comprises a plurality of transport-and-treatment elements adjacent to one another for transporting packages, wherein each of said transport-and-treatment elements can be driven to rotate said holding positions about said vertical machine axis.

37. The apparatus of claim 30, wherein said secondary parts are each configured with a format-adapted interchangeable mounting and base part.

38. The apparatus of claim 30, wherein said holding-and-centering units comprise pucks, wherein at said package input, each puck picks up a package, and wherein each puck is moved with said picked-up package from said package inlet to said package outlet along said package transport path, wherein upon arriving at said package outlet, each puck release said picked-up package, and wherein said apparatus further comprises a puck transport path over which pucks are returned from said package outlet back to said package inlet.

39. The apparatus of claim 38, wherein said puck transport path is at least in part constituted by those transport-and-treatment elements that are also part of said package transport path.

40. The apparatus of claim 38, further comprising receptacles formed between said holding positions to receive said pucks, wherein said receptacles are part of said puck transport path.

41. The apparatus of claim 30, further comprising, at each holding position, a holder configured as a carrier for holding a holding-and-centering element, wherein said holder is height-adjustable in a direction along said machine axis.

42. The apparatus of claim 30, further comprising, at each holding position, a mechanism for controlled holding and releasing of holding-and-centering elements.

43. The apparatus of claim 30, wherein said secondary part comprises an RFID tag.

44. The apparatus of claim 30, wherein each holding position comprises an inkjet print head and a radiation source for at least one curing and drying of ink, wherein said radiation source is selected from the group consisting of a thermal radiation source, a microwave radiation source, and a UV radiation source.

45. The apparatus of claim 44, wherein said print head is adjustable in at least one of a direction along said machine axis and an inclination relative to said machine axis.

46. The apparatus of claim 30, further comprising a supply line for carrying a pressure medium, wherein at least one transport-and-treatment element is connectable to said supply line, wherein said transport-and-treatment element comprises a distribution line to at least one handling station and at least one coupling element, wherein said holding-and-centering unit comprises a quick-acting coupling for coupling to said handling station, and wherein said pressure medium is selected from the group consisting of a gaseous medium, a vaporous medium, and compressed air, whereby a package held at a holding-and-centering unit at said transport-and-treatment element is pressurizable with said pressure medium.

47. The apparatus of claim 46, wherein said quick-acting coupling comprises a non-return valve such that after preloading a package with said pressure medium to a pressure, said pressure can be maintained in said package as said package traverses said package element transport section.

48. The apparatus of claim 30, wherein each holding-and-centering element comprises a holding-and-centering unit for passively holding a package with a spring force.

49. The apparatus of claim 30, wherein holding-and-centering units each comprise a recess configured to cover said package in a region of a mouth thereof.

50. The apparatus of claim 30, wherein said holding-and-centering units are held at an associated printing segment by passive application of a holding force to primary parts thereof, and wherein said the holding-and-centering units are actively removed from said printing segments.

51. The apparatus of claim 29, wherein said secondary part of said holding-and-centering unit comprises an electromagnetic direct drive for controlled handling of a package, wherein said electromagnetic direct drive comprises a rotor and a stationary structure, wherein said stationary structure is one of a stator and a solenoid array, and wherein said rotor comprises an array of permanent magnets that interact with said stationary structure.

52. The apparatus of claim 29, wherein said secondary part of said holding-and-centering unit comprises a format-adapted interchangeable mounting, a base part, and an infinitely variable and controllable electric motor, and wherein said primary part comprises a motor housing of said infinitely variable and controllable motor.

53. The apparatus of claim 29, wherein at least one of said primary part and said secondary part of said holding-and-centering unit comprises a coding, and an incremental sensor, wherein said coding indicates rotational angle position to said incremental sensor.

54. The apparatus of claim 29, wherein said holding-and-centering unit further comprising a sensor, wherein said primary part comprises a structure for enabling definition of a rotational angle position of said primary part relative to a respective holding position, wherein said sensor is configured to detect said rotational angle position, and wherein said structure is selected from the group consisting of a form-fitting mounting, and centering-or-coupling elements.

55. The apparatus of claim 29, wherein said holding-and-centering unit further comprises a coupling element, a mating piece for a coupling element for establishing a connection between a supply of a pressure medium and a treatment element, and a central inner line through a lower opening through which said pressure medium is guided into a package to load said package with a preload pressure, wherein said pressure medium is selected from the group consisting of vaporous medium, gaseous medium, and compressed air.

56. The apparatus of claim 55, wherein said mating piece comprises a non-return valve in said central inner line such that said preload pressure is maintained in said package while said package traverses said package transport section.
